(19) United States
(12) Patent Application Publication
(10) Pub. No.: US 2014/0017375 A1
(43) Pub. Date: Jan. 16, 2014

(54) Method And Apparatus For Producing A Confectionery Product From Multiple Components

(71) Applicant: Intercontinental Great Brands LLC, East Hanover, NJ (US)

(72) Inventors: Melis Abylov, Munich (DE); Gerhard Hecht, Kaufbeuren (DE); Mark Kijowski, Shanghai (CN); Stephan Simbuerger, Munich (DE)

(73) Assignee: Intercontinental Great Brands LLC, East Hanover, NJ (US)

(21) Appl. No.: 14/030,522

(22) Filed: Sep. 18, 2013

Related U.S. Application Data
(63) Continuation of application No. 12/442,301, filed on Sep. 3, 2009, now abandoned.

(30) Foreign Application Priority Data
Sep. 20, 2006 (EP) 06019675.5

(51) Int. Cl. A23G 1/00

(52) U.S. Cl. CPC A23G 1/0066
USPC 426/515

(57) ABSTRACT

The present disclosure relates to a method of producing a molded confectionery product, comprising the steps of transferring a fat-containing confectionery mass and a water carrier, blending the fat-containing confectionery mass and the water carrier in a mixer to a substantially homogeneous blended mass, and depositing the blended mass in at least one mould or onto a conveyor belt. The present disclosure is characterized in that the above steps are performed within 60 seconds or less. The apparatus for producing a molded confectionery product of the present disclosure comprises channels for transferring of a fat-containing confectionery mass and a water carrier, a mixer for blending the fat-containing confectioner mass and the water carrier to a substantially homogeneous blended mass, and at least one mixing nozzle for depositing of the blended mass.

### TECHNICAL FIELD

The present invention relates to a method of producing a confectionery product, preferably chocolate, according to the preamble of claim 1, and to an apparatus for producing a confectionery product, preferably chocolate, according to the preamble of claim 5.

### BACKGROUND OF THE INVENTION AND PRIOR ART

For producing confectionery products, for example chocolate, typically confectionery mass is deposited into mould cavities in order to produce for example a chocolate slab, tablet, bar, slice, chunk, etc.

A large variety of machines for depositing of confectionery products, chocolate articles in particular, is known. A number of such machines is engineered to mix two or more confectionery masses normally different in colour, basic components, and consistency.

EP 1 462 009 A1 teaches an apparatus with a depositor having a worm-like or screw-shaped insert. After supplying two different masses for example milk chocolate mass and white chocolate mass to the depositor, the masses are more or less mixed in order to reproduce the marbled look effect in chocolate mass prior to depositing.

Blending of conventional chocolate or compound chocolate mass with a water carrier imparts a degree of heat stability to the blend. However, upon addition of the water carrier the viscosity of the blend increases rapidly and becomes practically impossible to handle or mold and further results in a coarse and sandy sensation in the mouth. In U.S. Pat. No. 6,165,540 a process for manufacturing chocolate compositions containing water is described where molten chocolate mass at 45° C. is carefully incorporated in small quantities into water-in-oil emulsion using slight to moderate stirring. Further, the patent implies that a water-in-oil emulsion can be incorporated continuously in amass of chocolate or the like by means of one or more static mixers arranged in series.

### SUMMARY OF THE INVENTION

The basic problem addressed by the present invention is the method of production of a molded confectionery product, preferably chocolate, composed of a fat-containing confectionery mass and a water carrier, where the above components are blended uniformly and the blended mass is molded immediately upon blending.

This problem is solved by a method with the features of claim 1 and by an apparatus with the features of claim 5. Preferred embodiments are described in the respective subclaims.

The above object of the invention is essentially solved by minimizing the time span required for blending and molding, hence molding is completed prior to viscosity increase of the blend. The invention provides a method of producing a molded confectionery product, comprising the steps of transferring a fat-containing confectionery mass and a water carrier into mixing nozzle with static mixer inside, blending the fat-containing confectionery mass and the water carrier by static mixer to a substantially homogeneous blend, and depositing the blend in at least one mould or onto conveyor belt, whereby these steps are performed within 60 seconds or less, preferably within 35 seconds or less.

Thus, the time span for mixing and depositing of the chocolate blend is minimized, therefore viscosity increase of the blend is substantially avoided, further handling of the blend is easier and the quality of the finished product is raised. Transfer of the components into the mixing nozzle takes as short time as possible, specifically 1 second or less. The time span needed for the mixing process depends on the kind of the static mixer, the flow rate inside mixing nozzle, chemical-physical properties of the masses and the blend, etc. and measures between 11 and 30 seconds. Depositing of the blended mass is completed in approximately 2 seconds. All together 35 seconds or less, more preferably 20 seconds or less, or in particular around 15 seconds, are needed for the entire process.

A fat-containing confectionery mass is for example a chocolate mass or the like, while a water carrier is for instance a water-containing emulsion or the like. Transfer of the fat-containing confectionery mass and the water carrier into the mixing nozzles can be done in continuous or discontinuous way whereby the components are gauged prior to the transfer. The mixing element can for example be engineered as a static mixer inside mixing nozzle, a dynamic stirrer, an agitator, etc., and be mounted in a depositor. The mixing nozzle is preferably a tube, and is built into a piston depositor which enables gauging of the components from volume with further injecting into mixing nozzle in order to overcome the counter-pressure created by static mixer inside the mixing nozzle.

The above mentioned method enables to effectively mix the components and deposit a blend with water content of more than 1 percent, preferably more than 3 percent. The water content of the blend plays a key role in making it more heat-resistant.

In addition, the fat-containing confectionery mass and the water carrier might be transferred in isolation from each other into two tubes of the mixing nozzle with the mixer inside, wherein one tube is encircled by the other one, preferably coaxially. Thus, when injecting the two components into the mixing nozzle, the components are prevented from mixing beforehand. Further, mounting the mixer into the mixing nozzle reduces the size of the entire apparatus and provides the advantage that after mixing the mass can be deposited immediately.

Further, the fat-containing confectionery mass and the water carrier can be blended by a static mixer having at least one screw-shaped mixing element and/or at least one cross-flow mixing element. The screw-shaped mixing element, which has interruptions between the screw-sections, has the advantage that it provides little shear stress, while the cross-flow mixing element, which is an element with an irregular lattice-like structure of flow barriers, allows better mixing per given length. Screw-shaped mixing elements are also known as helical mixing elements, worms, helices, etc. The cross-flow mixing elements are referred to by different identifications at different manufacturers, e.g. “Sulzer” SMX, “Fluitec” CSE-X, “Komax” Ultra Mixer, etc.

The apparatus for producing a shaped confectionery product comprises channels for transferring of a fat-containing confectionery mass and a water carrier, a mixer for blending these two components to a substantially homogeneous blended mass, and a nozzle for depositing the blended mass, so that the apparatus can process the fat-containing confectionery mass and the water carrier within 35 seconds or less, measured from the time of transferring the masses to the time of depositing the blended mass into the at least one mould or on top of a conveyor belt or into any receptacle for enrobing. Thus, the processing time of the blended mass is minimized and its handling is simplified.

Further, the apparatus can comprise at least one nozzle plate, in which the channels are formed, and/or to which at least one mixing nozzle is mounted. If multiple nozzles are mounted, multiple moulds can be filled and/or one mould can be filled in shorter time and, therefore, the number of produced pieces per hour can be increased.

In addition, the apparatus can comprise at least one check valve in at least one transfer channel. Then, the fat-containing confectionery mass and the water carrier are prevented from flowing back despite the counter-pressure inside the mixing nozzle and, thus, no undesired mixing in the transfer channel and/or no leak of mass from the whole apparatus takes place.

### BRIEF DESCRIPTION OF THE DRAWINGS

FIG. 1 shows a sectional view of a part of the apparatus with a nozzle plate, one mixing nozzle and one mould;

FIG. 2A shows a mixing nozzle and a cross-flow mixing element;

FIG. 2B shows a mixing nozzle and a screw-shaped mixing element;

FIG. 3 shows a sectional view of a part of the apparatus with a nozzle plate, one mixing nozzle, one mould and a check valve in the inside tube.

### DETAILED DESCRIPTION OF THE PREFERRED EMBODIMENTS

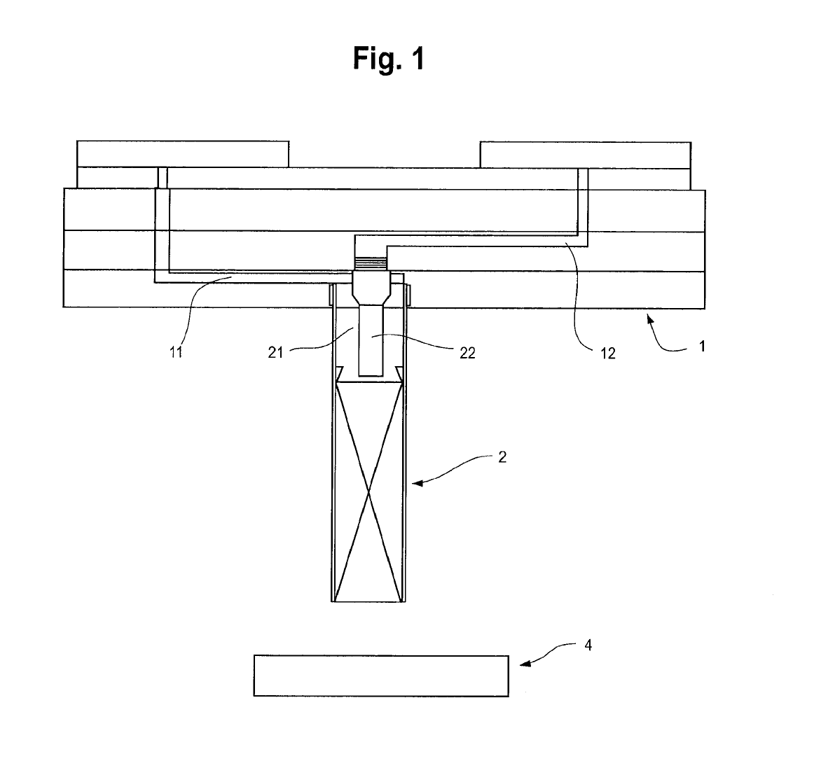

FIG. 1 shows a part of an apparatus for producing a molded confectionery product, comprising a nozzle plate 1 with transfer channels 11, 12 and a mixing nozzle 2 with two coaxial tubes 21, 22. Below the depositor, a mould 4 is depicted.

A fat-containing confectionery mass, for example a chocolate mass or the like, is transferred via the transfer channel 11, while a water carrier, for example a water-containing emulsion or the like, is transferred via the channel 12. The channels 11, 12 can be formed as separate lines or tubes inside a hollow plate or as bores in a solid plate. Transfer channel 11 is connected to outside tube 21, while transfer channel 12 is connected to inside tube 22. In the embodiment shown, outside tube 21 encircles inside tube 22 coaxially. Thus, the fat-containing confectionery mass and the water carrier can be injected into the mixing nozzle 2 in isolation from each other. The upper part of the mixing nozzle 2 comprises the tubes 21, 22, while static mixers 23, 24 is mounted or integrated into the lower part of the mixing nozzle 2.

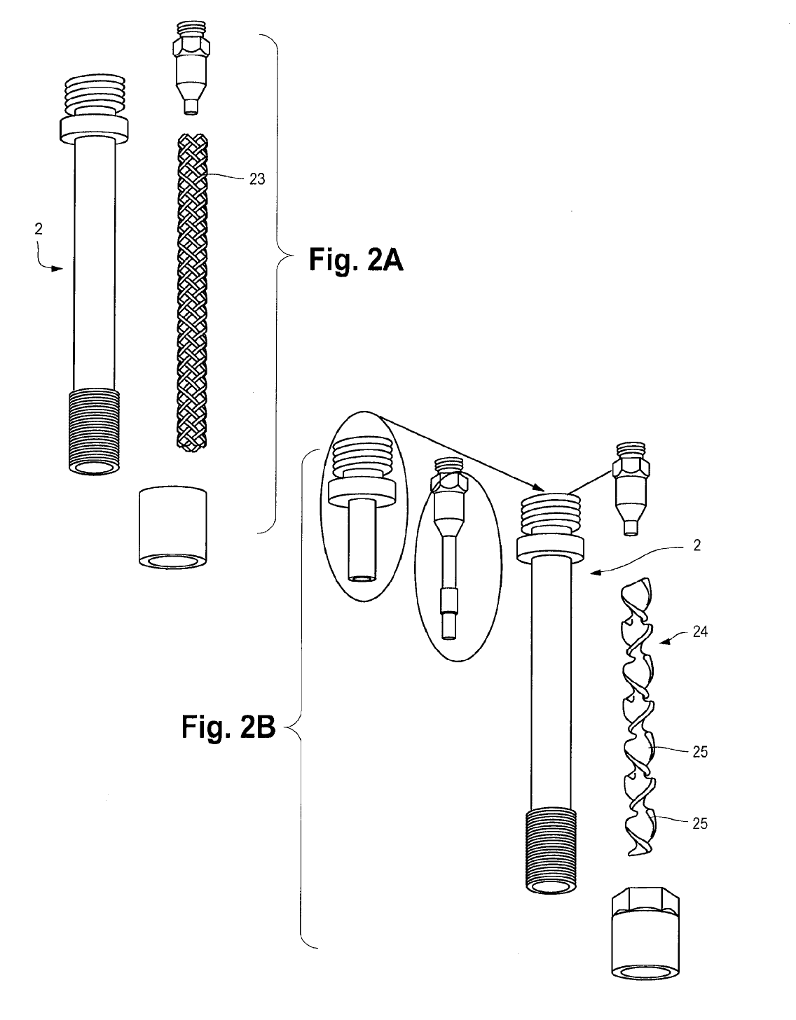

In FIG. 2A, a mixing nozzle 2 is shown wherein the cross-flow mixing element 23 or the screw-shaped mixing element 24 is inserted. Screw-shaped mixing element is shown in FIG. 2B. The cross-flow mixing element 23 is a cylinder-shaped lattice-like structure of flow-barriers with better mixing per given length compared to the screw-shaped mixing element. The screw-shaped mixing element 24 has several interruptions forming various screw-sections 25 with reduced shearing compared to the cross-flow mixing element.

After injecting the fat-containing confectionery mass and the water carrier from the respective tubes 21, 22, components pressed towards the mixing nozzle and get blended by at least one screw-shaped or worm-like mixing element 24 and/or by at least one cross-flow mixing element 23 or by any combination from screw-shaped and cross-flow mixing elements. After mixing the two components to a homogeneous mass, the blended mass can be immediately deposited into moulds 4 or into individual mould cavities of a moulding form or on top of a conveyor belt with or without cavities.

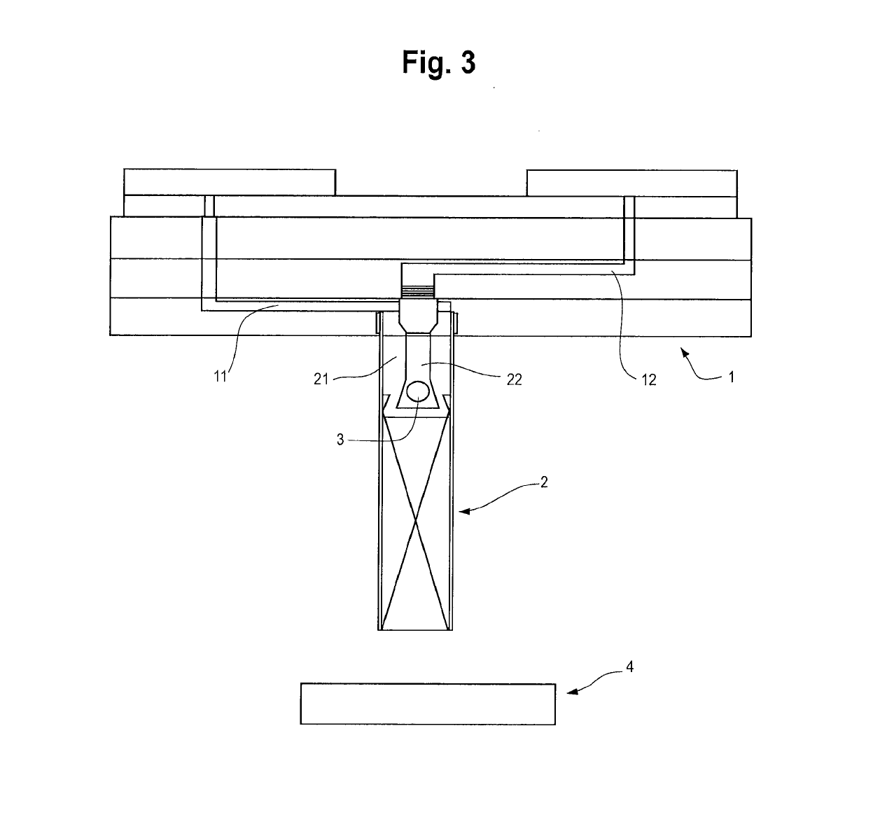

FIG. 3 shows a further embodiment of a part of an apparatus for producing a molded confectionery product, where the aforementioned components are designated by the same reference numbers. In FIG. 3 a check valve 3 mounted in tube 22 is shown. Certainly, it also might be possible to mount a check valve 3 in channel 21 and/or in at least one of the channels 11, 12. In this embodiment, outlet of the tube 22 is shaped as a truncated cone, while the tube also can have a normal cylindrical shape, as shown in FIG. 1.

1. A method of producing a molded confectionery product, comprising:
a) transferring a fat-containing confectionery mass and a water carrier to at least one mixing nozzle;
b) blending the fat-containing confectionery mass and the water carrier by a mixer in the mixing nozzle to a substantially homogeneous blended mass; and
c) depositing the blended mass into at least one mold,
wherein the above steps are performed within a total time of 60 seconds or less, to substantially avoid viscosity increase of the blended mass.

2. The method of producing a molded confectionery product according to claim 1, wherein the water content in the blended mass is more than 1 percent.

3. The method of producing a molded confectionery product according to claim 1, wherein the fat-containing confectionery mass and the water carrier are injected separately into two tubes of the mixing nozzle, wherein one of the two tubes, an inside tube, is encircled by the other of the two tubes, an outside tube.

4. The method of producing a molded confectionery product according to claim 1, wherein the mixer is a static mixer made of at least one screw-shaped mixing element and/or at least one cross-flow mixing element and the fat-containing confectionery mass and the water carrier are blended by the static mixer.

5.-10. (canceled)

11. The method of producing a molded confectionery product according to claim 1, wherein the steps (a)-(c) are performed within a total time of 35 seconds or less.

12. The method of producing a molded confectionery product according to claim 2, wherein the water content in the blended mass is more than 3 percent.

13. The method of producing a molded confectionery product according to claim 1, wherein the fat-containing confectionery mass is a chocolate mass.

14. A method of producing a molded confectionery product, comprising:
a) transferring a fat-containing chocolate mass and a water carrier to at least one mixing nozzle;
b) blending the fat-containing chocolate mass and the water carrier by a static mixer in the mixing nozzle to form a blended mass, the blended mass having a first viscosity; and
c) depositing the blended mass into at least one mold to form a deposited mass,
wherein the above steps are performed within a total time of 35 seconds or less, effective to provide the deposited mass with a second viscosity about the same as the first viscosity.
